(19) United States
(12) Patent Application Publication
(10) Pub. No.: US 2019/0168882 A1
(43) Pub. Date: Jun. 6, 2019

(54) ROTARY-WING AERODYNE WITH PARACHUTE

(71) Applicant: HELI-TECH, Tain L'hermitage (FR)

(72) Inventor: Pascal Jean-Fulcrand, Baix (FR)

(21) Appl. No.: 16/323,140

(22) PCT Filed: Aug. 6, 2017
(86) PCT No.: PCT/EP2017/069876

§ 371 Date: Feb. 4, 2019

(30) Foreign Application Priority Data
Aug. 8, 2016 (FR) 1657621

(51) Int. Cl. B64D 17/80; B64C 27/00; B64D 17/22

(52) U.S. Cl. CPC B64D 17/80; B64D 17/22; B64C 27/006

(57) ABSTRACT

A rotary-wing aerodyne includes a motor, a structure supporting at least one passenger seat, and a rotor arranged above the structure and linked to the motor by a hollow transmission shaft. The transmission shaft is movable in rotation relative to the structure. The aerodyne also includes a hollow mast attached to the structure and extending through the transmission shaft, and a parachute arranged above the rotor. The parachute is attached to the mast and linked to the structure by means of a suspension element passing through the mast. The suspension element is produced from a multi-strand steel cord with a tensile strength of greater than 150 daN/mm².

### TECHNICAL FIELD

The present disclosure concerns the field of rotary-wing aerodynes such as Gyro copters and helicopters.

More particularly, the disclosure concerns rotary-wing aerodynes incorporating a parachute which, once deployed, is capable of supporting the weight of the aerodyne.

### BACKGROUND

An aerodyne conventionally comprises a structure, for example tubular, supporting at least one motor and at least one passenger seat. The lift of the aerodyne is provided by at least two blades movable in rotation above the structure. The blades are attached to a rotor driven by the motor by means of a transmission shaft.

The movement of the aerodyne is produced by changing the orientation of the blades by means of a swash plate arranged around the transmission shaft between the rotor and the structure. The aerodyne includes a cockpit provided with a joystick suitable for changing the orientation of the swash plate in order to control the movements of the aerodyne.

There are critical situations wherein an aerodyne becomes uncontrollable such as the breakdown of the swash plate controls, engine problems, etc. These situations can cause the aerodyne to crash. Furthermore, due to the presence of the rotary wing above the cabin of an aerodyne it is generally not possible for passengers to extricate themselves from the aerodyne with a parachute without colliding with the rotary wing.

To improve the chances of passenger survival, there are helicopters incorporating a parachute intended to support the weight of the aerodyne and passengers.

A parachute comprises a canopy and shrouds. It is generally positioned above the rotor in order to avoid the shrouds colliding with the blades. The shrouds are attached above the rotor to a fixed point relative to the structure of the aerodyne. The deployment of the parachute is provided by a fuze controlled from the cabin in such a way as to quickly deploy the canopy of the parachute. This type of device is described in U.S. Pat. No. 2,812,147.

As a variant, Chinese utility model No. CN 2 444 879 describes a helicopter incorporating a parachute incorporating a suspension strap passing through a recess of the transmission shaft. The suspension strap is attached to the structure of the helicopter.

The triggering of the parachute often results in rendering the controls of the aerodyne inoperative because the blades no longer provide lift for the aerodyne. It is at that point that the parachute must be as reliable as possible.

During a serious breakdown, a blade can become disengaged from the rotor causing a thrust in the order of 9806 daN (10 tons) on the remaining blades. This results in the serious phenomenon of imbalance which misaligns the transmission shaft and risks destroying the elements present between the rotor and the structure. In this very serious case, when the parachute is attached above the rotor, it risks becoming detached and the shroud lines risk being cut by the debris from the blades. Moreover, when the parachute is attached to the structure of the helicopter, the transmission shaft can also chafe against the suspension strap until it is cut.

There is thus a technical problem of guaranteeing the integrity of the attachment of a parachute of a helicopter during the disengagement of a blade from the transmission shaft.

To respond to this technical problem, it is known to use blades that are ejectable at the transmission shaft. However, the use of the ejectable blades requires a complex installation. To date, only the military is capable of implementing this type of ejectable blades with the required safety measures.

### SUMMARY OF THE DISCLOSURE

The present disclosure proposes a variant to the use of ejectable blades by means of a suspension cable wherein the structure thereof makes it possible to withstand friction from the transmission shaft that could cut a conventional suspension.

To that end, the described embodiments concern a rotary-wing aerodyne, the said aerodyne comprising:

a motor;

a structure supporting at least one passenger seat;

a rotor arranged above the said structure and linked to the motor by a hollow transmission shaft, the transmission shaft being movable in rotation relative to the structure;

a hollow mast attached to the structure and extending through the transmission shaft; and

a parachute arranged above the rotor, the parachute being attached to the mast and linked to the structure by means of a suspension element passing through the mast.

The disclosed embodiments are characterised in that the said suspension element is produced from a multi-strand steel cable with tensile strength of greater than 150 daN/mm².

The inventor has found that this solution is particularly effective for responding to the technical problem of cutting the suspension element during the dislocation of the transmission shaft. Indeed, a steel cable is particularly strong for withstanding shear stresses. Moreover, the multi-strand structure of the cable enables it to be easily deformed in order to absorb the shear stresses. The tensile strength of at least 150 daN/mm² ensures that the aerodyne is preserved even when the imbalance phenomenon greatly increases the tensile stress of the cable.

The result is that the disclosed embodiments make it possible to ensure the connection between the canopy of the parachute and the structure of the aerodyne, even during a serious breakdown.

When a blade becomes disengaged from the rotor, there is a transitory phenomenon wherein the elements present between the parachute and the structure of the aerodyne risk being damaged and the cable being cut. Even in the most unfavorable case wherein the transmission shaft chafes against the suspension cable, it successively and slowly cuts the strands, allowing the cable to resist up until the end of the transitory phenomenon.

Furthermore, this solution is particularly counter intuitive for a person skilled in the art seeking to produce an aerodyne because the use of a steel cable negatively impacts the weight of an aerodyne. Now, a person skilled in the art who seeks to produce an aerodyne is constantly searching for ways to limit weight.

According to one embodiment, the said cable has a flexibility enabling it to be curved over a radius of less than or equal to 10 times the diameter thereof without reaching the bending elastic limit thereof. This embodiment allows the cable to absorb the shearing stresses.

According to one embodiment, the said cable has a tensile breaking strength of more than 10 times the maximum authorized weight of said aerodyne even though a cross-section of said cable is reduced by 95%. To perform this measurement, 95% of the metal cross section of the cable is cut and a tensile test is performed. This embodiment makes it possible to guarantee the link between the parachute and the aerodyne even when the transmission shaft chafes against the cable and cuts a large part of the strands of the multi-strand cable.

According to one embodiment, the said parachute incorporates an extractor, said extractor being manually controlled from the cockpit of the aerodyne. This embodiment enables the pilot to extract the parachute when he determines that damage has occurred that he is unable to control.

According to one embodiment, the said extractor is controlled by a ripcord passing through said mast. This embodiment enables the recess of the mast to be reused for passing through a manual control.

According to one embodiment, the said extractor is controlled by an electrical switch, said electrical switch being connected to said cockpit by at least one electric wire passing through said mast. This embodiment enables the recess of the mast to be reused for passing through an electric wire.

According to one embodiment, the said extractor is controlled by wireless transmission means. This embodiment makes it possible to avoid the trouble of passing the suspension cable through the mast with an electric wire or a manual ripcord.

According to one embodiment, the said parachute incorporates an extractor, said extractor being controlled automatically when certain abnormal parameters are detected. This embodiment enables the parachute to be triggered automatically if the pilot becomes indisposed or when the centrifugal forces are such that the pilot is unable to reach the manual trigger control.

According to one embodiment, the said extractor is implemented by means of a mechanical percussion device configured to ensure the extraction of the said parachute when the rotor has a lateral acceleration greater than a threshold value.

According to one embodiment, the said extractor is implemented by means of a switch-controlled electro-mechanical device configured such as to ensure the extraction of said parachute when the rotor has a lateral acceleration greater than a threshold value.

According to one embodiment, the said extractor is implemented by means of an electronic device configured such as to ensure the extraction of said parachute when the aerodyne has an angular acceleration greater than a threshold value.

According to one embodiment, the said extractor comprises a first trigger mechanism that is manually controlled from the cockpit of the aerodyne and a second trigger mechanism that is controlled automatically when certain abnormal parameters are detected.

According to one embodiment, the said suspension cable is attached to said structure by at least two attachment tethers connected to two different attachment points of said structure. This embodiment makes it possible to preserve the suspension cable if one of the two attachment tethers breaks. Furthermore, the structure can suffer damage during the disintegration of the transmission shaft. This embodiment enables the said cable to be preserved even when part of the structure is damaged.

### BRIEF DESCRIPTION OF THE FIGURES

The method for implementing the disclosed embodiments and their advantages will become more apparent from the following disclosure of the embodiment, given by way of a non-limiting example, supported by the attached figures in which FIGS. 1 to 3 represent:

FIG. 1: a side view of an aerodyne supported by a parachute according to one embodiment;

FIG. 2: a schematic representation in cross section of the aerodyne of FIG. 1; and

FIG. 3: a schematic representation in partial cross section of the transmission column of the aerodyne of FIG. 1.

### DETAILED DESCRIPTION

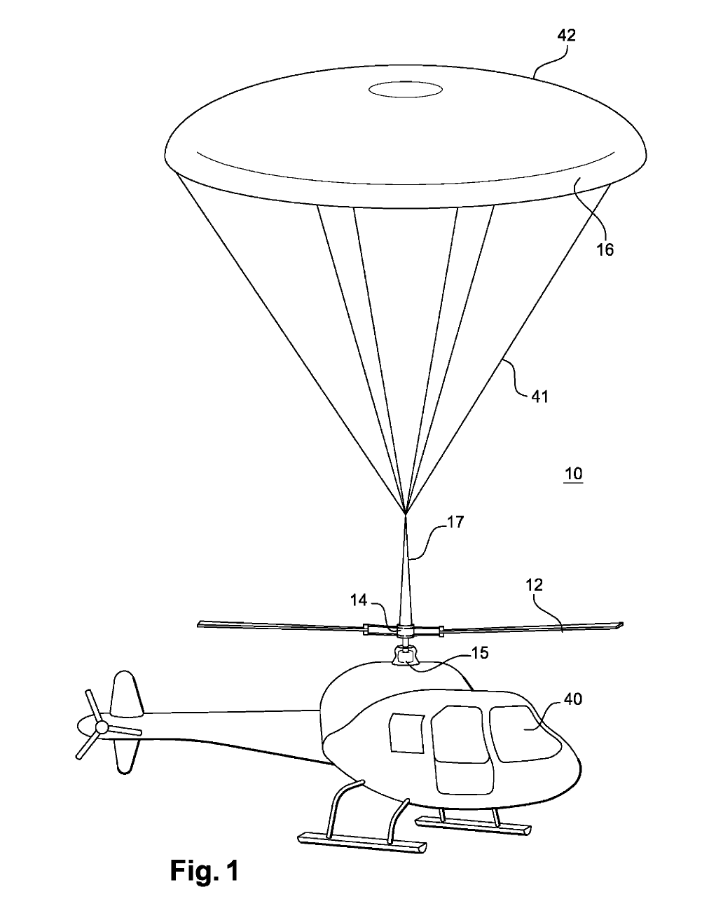

FIGS. 1 to 3 illustrate an aerodyne 10 comprising a metal tubular structure 11 supporting at least one passenger seat as well as a motor 35. The motor 35 drives in rotation a rotor 14, arranged above the structure 11, by means of a transmission shaft 13. The lift of the aerodyne 10 is produced by two blades 12 attached to the rotor 14.

The movement of the aerodyne 10 is produced by changing the orientation of the blades 12 by means of a swash plate 15 arranged around the transmission shaft 13 between the rotor 14 and the structure 11. The aerodyne 10 includes a cockpit 40 provided with a joystick suitable for changing the orientation of the swash plate 15 in order to control the movements of the aerodyne 10.

The transmission shaft 13 is a hollow metal part wherewithin a mast 30 is inserted. The mast 30 is attached to the structure 11 and the transmission shaft 13 is movable in rotation around the mast 30. The rotor 14 as well as the swash plate 15 have a central recess wherewithin the mast 30 is inserted. The mast 30 thus extends above the rotor 14 in such a way as to attach a parachute 16 securely to the structure 11.

More specifically, the parachute 16 is incorporated into a housing 31 incorporating the canopy 42 of the parachute 16 as well as the shrouds 41 thereof and the elements for extracting the parachute 16 from the housing 31. As illustrated in FIG. 1, when the parachute 16 is deployed the shrouds 41 connect different points of the canopy 42 to a suspension cable 17. The form of the parachute 16 can vary without departing from the contemplated embodiments. For example, the parachute 16 can comprise a plurality of canopies 42.

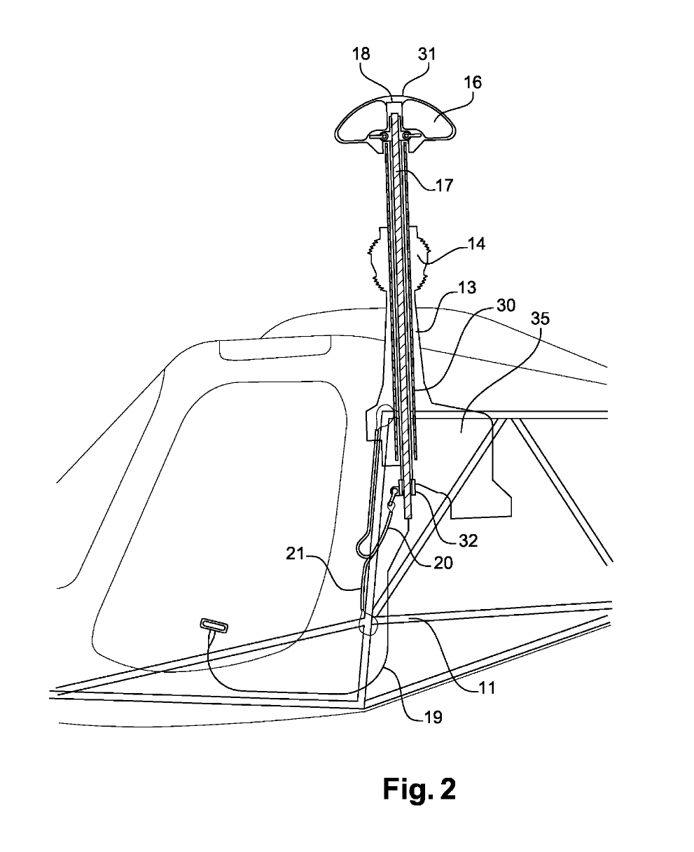

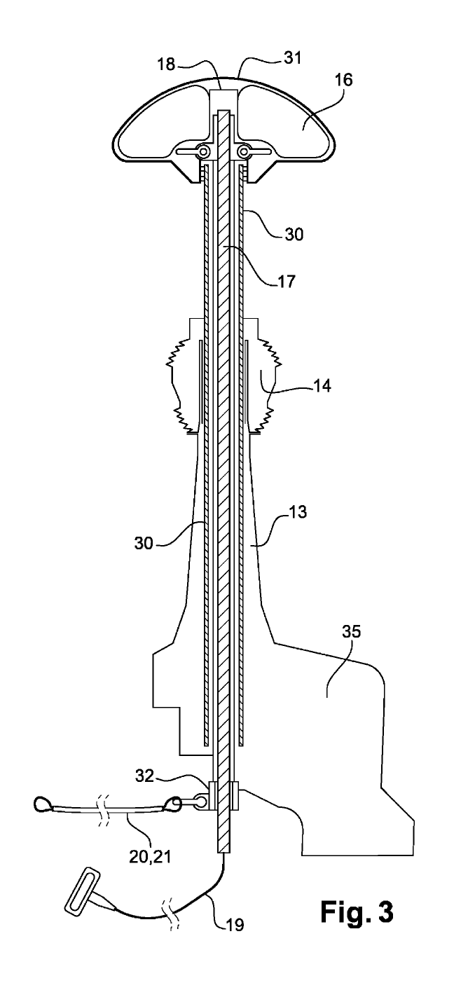

The suspension cable 17 passes through the mast 30 in order to be secured to the structure 11 of the aerodyne 10. The suspension cable 17 can be secured to the structure 11 in using any known means. FIGS. 2 and 3 illustrate an embodiment wherein the suspension cable 17 is secured by a shackle 32 around the suspension cable 17. The shackle 32 is connected to two attachment tethers 20, 21 connected to two different attachment points of the structure 11. A first attachment tether 20 is secured around a tube of the structure 11 close to the motor 35. A second attachment tether 21 is secured around a tube of the structure 11 close to the floor of the aerodyne 10.

The suspension cable 17 is an essential element of the contemplated embodiments because it makes it possible to withstand the deterioration of the blades 12, the mast 30 and/or the transmission shaft 13. To do this, the suspension cable 17 is produced from a multi strand steel cable with a tensile strength of greater than 150 daN/mm². Preferably, the suspension cable 17 has a flexibility enabling it to be curved over a radius of less than or equal to 10 times the diameter thereof without reaching the bending elastic limit thereof. Preferably, the suspension cables 17 has a tensile breaking strength of more than 10 times the maximum authorized weight of said aerodyne when a cross-section of said cable 17 is reduced by 95%. For example, a hoisting cable with a cross-section of 20 mm can be used.

The elements for extracting the parachute 16 from the housing 31 include an extractor 18, for example a fuze, and a trigger mechanism of the extractor 18. The trigger mechanism can be mechanical, electrical or electronic. For example, as illustrated in FIGS. 2 and 3, the trigger mechanism can be produced by a ripcord 19 passing through said mast 30. The cross-section of the ripcord 19 is far smaller than that of the suspension cables 17 because the ripcord 19 can be cut without impairment after the opening of the parachute 17. Typically, the cross-section of the ripcord 19 can be in the order of 1 or 2 mm. The said ripcord 19 makes it possible to ensure manual control of the opening of the parachute 16 from the cockpit 40.

As a variant, manual control of the opening of the parachute 16 can be achieved by an electrical switch by means of an electric wire passing through the mast 30. As a variant, manual control can be achieved by means of wireless transmission. A wireless transmitter is then arranged within the cockpit 40 and a receiver is arranged at the parachute 16.

Moreover, the opening of the parachute 16 can also be controlled automatically when certain abnormal parameters are detected. The automatic triggering can be achieved by a mechanical percussion device configured such as to ensure the extraction of the parachute 16 when the rotor 14 has a lateral acceleration greater than a threshold value. To that end, a gyroscopic sensor is incorporated into the trigger mechanism. As a variant, the automatic triggering can be achieved by a switch-controlled electro-mechanical device configured such as to ensure the extraction of the parachute 16 when the rotor 14 has a lateral acceleration greater than a threshold value. As a variant, the automatic triggering can be achieved by an electronic device configured such as to ensure the extraction of the parachute 16 when the aerodyne 10 has an angular acceleration greater than a threshold value. To that end, a gyroscopic sensor is incorporated into the structure of the aerodyne 10.

When the trigger and/or extractor incorporate one or more electric accumulators involved in the operation thereof, the cockpit 40 includes a charge indicator of the accumulators.

Preferably, the aerodyne 10 incorporates two means of triggering the parachute 16, a manual control operated by the pilot and an automatic control if the pilot is unable to manually trigger the extraction of the parachute 16.

The contemplated embodiments thus make it possible to ensure greater passenger safety by means of a parachute 16 resistant to the significant damage that could occur between the parachute 16 and the structure 11.

1. A rotary-wing aerodyne, the said aerodyne comprising:
a motor;
a structure supporting at least one passenger seat;
a rotor arranged above the said structure and linked to the motor by a hollow transmission shaft, the transmission shaft being movable in rotation in relation to the structure;
a hollow mast attached to the structure and extending through the transmission shaft; and
a parachute arranged above the rotor, the parachute being attached to the mast and linked to the structure by means of a suspension element passing through the mast;
wherein said suspension element is produced from a multi-strand steel cable with a tensile strength of greater than 150 daN/mm².

2. The aerodyne according to claim 1, wherein the said cable has a flexibility enabling it to be curved over a radius of less than or equal to 10 times the diameter thereof without reaching the bending elastic limit thereof.

3. The aerodyne according to claim 1, wherein said cable has a tensile breaking strength of more than 10 times the maximum authorized weight of said aerodyne even though a cross-section of said cable is reduced by 95%.

4. The aerodyne according to claim 1, wherein said parachute incorporates an extractor, said extractor being manually controlled from a cockpit of the aerodyne.

5. The aerodyne according to claim 4, wherein said extractor is controlled by a ripcord passing through said mast.

6. The aerodyne according to claim 4, wherein said extractor is controlled by an electrical switch, said electrical switch being connected to said cockpit by at least one electric wire passing through said mast.

7. The aerodyne according to claim 4, wherein said extractor is controlled by wireless transmission means.

8. The aerodyne according to claim 1, wherein said parachute incorporates an extractor, said extractor being controlled automatically when certain abnormal parameters are detected.

9. The aerodyne according to claim 8, wherein said extractor is achieved by a mechanical percussion device configured such as to ensure the extraction of said parachute when the rotor has a lateral acceleration greater than a threshold value.

10. The aerodyne according to claim 8, wherein said extractor is achieved by a switch-controlled electro-mechanical device configured such as to ensure the extraction of said parachute when said rotor has a lateral acceleration greater than a threshold value.

11. The aerodyne according to claim 8, wherein said extractor is achieved by an electronic device configured such as to ensure the extraction of said parachute when said aerodyne has an angular acceleration greater than a threshold value.

12. The aerodyne according to claim 1, wherein said suspension cable is attached to said structure by at least two attachment tethers connected to two different attachment points of said structure.
